(19) United States
(12) Patent Application Publication
(10) Pub. No.: US 2005/0031088 A1
(43) Pub. Date: Feb. 10, 2005

(54) Radiographic apparatus and radiation detection signal processing method

(76) Inventors: Shoichi Okamura, Nara-ken (JP); Keiichi Fujii, Kyoto-fu (JP); Susumu Adachi, Osaka-fu (JP); Shinya Hirasawa, Kyoto-fu (JP); Toshinori Yoshimuta, Osaka-fu (JP); Koichi Tanabe, Kyoto-fu (JP); Shigeya Asai, Kyoto-fu (JP); Akihiro Nishimura, Kyoto-fu (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/887,920

(22) Filed: Jul. 12, 2004

(30) Foreign Application Priority Data
Aug. 8, 2003 (JP) JP2003-290331

(51) Int. Cl. H05G 1/00

(52) U.S. Cl. 378/210

(57) ABSTRACT

A subtraction image is obtained, by a subtraction process (DSA process), from a live image and a mask image. A lag-behind part included in each X-ray detection signal is considered due to an impulse response formed of exponential functions. The lag-behind part is removed from each X-ray detection signal by a recursive computation to obtain a corrected X-ray detection signal. The live image and mask image are obtained from such corrected detection signals.

### BACKGROUND OF THE INVENTION

(1) Field of the Invention

This invention relates to a radiographic apparatus for medical or industrial use and a radiation detection signal processing method, for obtaining radiographic images based on radiation detection signals fetched at predetermined sampling time intervals by a signal sampling device from a radiation detecting device as radiation is emitted from a radiation emitting device. More particularly, the invention relates to a technique for improving an image quality vulnerable to impairment of DSA (subtraction process) images due to time lags occurring with the radiation detecting device.

(2) Description of the Related Art

Conventionally, a type of radiographic apparatus is designed for use in digital subtraction angiography (DSA) to observe the conditions of blood vessels of a patient. This apparatus is operable to perform X-ray radiography of a predetermined site of the patient before injection of a contrast medium, and then radiograph the same site of the patient after injection of the contrast medium. An X-ray image (i.e. a live image) of the patient with the contrast medium injected is an image clearly visualizing a blood vessel. From this X-ray image an X-ray image (i.e. a mask image) obtained before injection of the contrast medium and not showing the blood vessel definitely is subtracted, to obtain a subtraction image enhancing only the blood vessel. While the subtraction process is a deducting operation, an arithmetic mean may be determined of mask images obtained through a plurality of radiographic operations, or a weighted arithmetic mean may be determined of live images obtained continually, in order to improve the signal to noise ratio, as disclosed in Japanese Unexamined Patent Publication No. 2000-41973.

However, where a flat panel X-ray detector (hereinafter called “FPD” as appropriate) having numerous X-ray detecting elements arranged longitudinally and transversely on an X-ray detecting surface is used as a radiation detector (radiation detecting device) for detecting such images, time delays of the FPD could cause after-images. Thus, a problem of after-images arises unless lag-behind parts are fully eliminated.

### SUMMARY OF THE INVENTION

This invention has been made having regard to the state of the art noted above, and its object is to provide a radiographic apparatus and a radiation detection signal processing method for fully eliminating time lags, due to a radiation detecting device, of radiation detection signals taken from the radiation detecting device, thereby obtaining a subtraction image with high accuracy.

To fulfill the above object, Inventors have noted that after-images and the like due to time delays of the FPD correspond to lag-behind parts included in radiation detection signals taken at sampling time intervals. The following technique is conceivable to remove such lag-behind parts. In dealing with the time lags of the FPD, this technique removes a lag-behind part due to an impulse response based on the following recursive equations A-C:
Xₖ=Yₖ−Σₙ₌₁^{N}{αₙ·[1−exp(Tₙ)]·exp(Tₙ)·Sₙₖ} A
Tₙ=−Δt/τₙ B
Sₙₖ=Xₖ₋₁+exp(Tₙ)·Sₙ₍ₖ₋₁₎ C
where Δt: the sampling time interval;
k: a subscript representing a k-th point of time in a sampling time series;
Yₖ: an X-ray detection signal taken at the k-th sampling time;
Xₖ: a corrected X-ray detection signal with a lag-behind part removed from the signal Yₖ;
Xₖ₋₁: a signal Xₖ taken at a preceding point of time;
Sₙ₍ₖ₋₁₎: an Sₙₖ at a preceding point of time;
exp: an exponential function;
N: the number of exponential functions with different time constants forming the impulse response;
n: a subscript representing one of the exponential functions forming the impulse response;
αₙ: an intensity of exponential function n; and
τₙ: an attenuation time constant of exponential function n.

In the above recursive computation, coefficients of the impulse response of the FPD, N, αₙ and τₙ, are determined in advance. With the coefficients fixed, X-ray detection signal Yₖ is applied to equations A-C, thereby obtaining a lag-free X-ray detection signal Xₖ.

A specific example of the above technique will be described with reference to FIGS. 6 and 7. FIG. 6 is a view showing a state of radiation incidence. FIG. 7 is a view showing time delays. In these figures, the vertical axis represents incident radiation intensity, and time t0-t1 represents radiography for a mask image, while time t2-t3 represents radiography for a live image. When, as shown in FIG. 6, an incidence of radiation takes place during time t0-t1 and time t2-t3, lag-behind parts shown in hatching in FIG. 7 add to normal signals corresponding to the incident doses. This results in radiation detection signals Yₖ shown in thick lines in FIG. 7.

As shown in FIG. 7, after the radiography for a mask image and before the radiography for a live image, impulse responses corresponding to the mask image, i.e. components of the radiation detection signals, while attenuating, actually remain though small in amount. Consequently, when the radiography for a live image is carried out intermittently, and not continuously, after the radiography for a mask image, that is when radiography is performed by breaking a continuation in time between the mask image and live image, even if time delays are removed for each image, the time delays for the mask image overlap the removal of the time delays for the live image. It is seen, therefore, that the time lags cannot fully be eliminated, resulting in an after-image. Then, a DSA process may be carried out with advantage to remove all influential lag-behind parts from the radiation detection signals actually obtained to create images such as a live image and a mask image.

Based on the above findings, this invention provides a radiographic apparatus having a radiation emitting device for emitting radiation toward an object under examination, a radiation detecting device for detecting radiation transmitted through the object under examination, and a signal sampling device for taking radiation detection signals from the radiation detecting device at predetermined sampling time intervals, to obtain a live image and a mask image based on the radiation detection signals outputted from the radiation detecting device at the predetermined sampling time intervals as radiation is emitted to the object under examination, the live image and the mask image being subjected to a subtraction process to obtain a subtraction image, the apparatus comprising:
a time lag removing device for removing lag-behind parts from the radiation detection signals by a recursive computation, on an assumption that a lag-behind part included in each of the radiation detection signals taken at the predetermined sampling time intervals is due to an impulse response formed of one exponential function or a plurality of exponential functions with different attenuation time constants;
wherein, in order to pick up the live image and the mask image continually, the radiation detection signals relating to the live image and the radiation detection signals relating to the mask image are continually detected at the sampling time intervals, the lag-behind parts being removed from the radiation detection signals by the time lag removing device to obtain corrected radiation detection signals for forming the live image and the mask image, and obtaining the subtraction image.

With the radiographic apparatus according to this invention, radiation detection signals are outputted from the radiation detecting device at predetermined sampling time intervals as radiation is emitted from the radiation emitting device to an object under examination. A live image and a mask image are obtained from these radiation detection signals, and are subjected to a subtraction process to obtain a subtraction image. A lag-behind part included in each of the radiation detection signals taken at the sampling time intervals is regarded as due to an impulse response formed of one exponential function or a plurality of exponential functions with different attenuation time constants. Such lag-behind parts are removed from the radiation detection signals by a recursive computation to obtain corrected radiation detection signals. In order to pick up a live image and a mask image continually, radiation detection signals for the live image and radiation detection signals for the mask image are continually detected at the sampling time intervals. Thus, the lag-behind parts of these signals are linked in time. When an image accompanying the lag-behind parts is picked up and thereafter a different image is picked up, the lag-behind parts influence the latter image also. Such lag-behind parts influencing one another are used to eliminate fully the time delays of the radiation detection signals due to the radiation detecting device. The live image and mask image are obtained from the corrected detection signals having the mutually influencing lag-behind parts removed. Consequently, the lag-behind parts are fully removed from the subtraction image obtained by performing the subtraction process on the live image and mask image.

In the above radiographic apparatus, the time lag removing device, preferably, is arranged to perform the recursive computation for removing the lag-behind part from each of the radiation detection signals, based on the following equations A-C:
Xₖ=Yₖ−Σₙ₌₁^{N}{αₙ·[1−exp(Tₙ)]·exp(Tₙ)·Sₙₖ} A
Tₙ=−Δt/τₙ B
Sₙₖ=Xₖ₋₁+exp(Tₙ)·Sₙ₍ₖ₋₁₎ C
where Δt: the sampling time interval;
k: a subscript representing a k-th point of time in a sampling time series;
Yₖ: a radiation detection signal taken at the k-th sampling time;
Xₖ: a corrected radiation detection signal with a lag-behind part removed from the signal Yₖ;
Xₖ₋₁: a signal Xₖ taken at a preceding point of time;
Sₙ₍ₖ₋₁₎: an Sₙₖ at a preceding point of time;
exp: an exponential function;
N: the number of exponential functions with different time constants forming the impulse response;
n: a subscript representing one of the exponential functions forming the impulse response;
αₙ: an intensity of exponential function n; and
τₙ: an attenuation time constant of exponential function n.

Where the recursive computation for removing the lag-behind part from each of the radiation detection signals is based on equations A-C, the corrected, lag-free radiation detection signal Xₖ may be derived promptly from equations A-C constituting a compact recurrence formula.

The mask image and live image may be obtained by using the corrected, lag-free radiation detection signals Xₖ derived from the recurrence formula, as follows.

The mask image may be created by deriving an arithmetic mean of the corrected radiation detection signals Xₖ from the following equation D:

$$\begin{matrix}M = ( 1 / J ) \cdot ( {X}_{1} … + {X}_{k - 1} + {X}_{k} + … + {X}_{J} ) \\ = 1 / J \cdot {\sum }_{k = 1}^{J} [ {X}_{k} ]\end{matrix} \qquad D$$

where M: mask image; and
J: the number of signals Xₖ for creating the mask image.

The live image may be created by a recursive process based on the following equation E showing a weighted mean of the corrected radiation detection signals Xₖ:
Rₖ=(1/K)·Xₖ+(1−1/K)·Rₖ₋₁ E
where Rₖ: live image after a k-th recursive process;
Rₖ₋₁: Rₖ at a preceding point of time; and
K: weight factor for the recursive process.

In the radiographic apparatus, one example of the radiation detecting device is a flat panel X-ray detector having numerous X-ray detecting elements arranged longitudinally and transversely on an X-ray detecting surface.

The radiographic apparatus according to this invention may be a medical apparatus, and an apparatus for industrial use as well. An example of medical apparatus is a fluoroscopic apparatus. Another example of medical apparatus is an X-ray CT apparatus. An example of apparatus for industrial use is a nondestructive inspecting apparatus.

In another aspect of the invention, a radiation detection signal processing method is provided for taking, at predetermined sampling time intervals, radiation detection signals generated by irradiating an object under examination, creating a live image and a mask image based on the radiation detection signals outputted at the predetermined sampling time intervals, and performing a signal processing to obtain a subtraction image through a subtraction process, the method comprising the steps of:
(a) continually detecting the radiation detection signals relating to the live image and the radiation detection signals relating to the mask image at the sampling time intervals in order to pick up the live image and the mask image continually;
(b) removing lag-behind parts from the radiation detection signals by a recursive computation, on an assumption that a lag-behind part included in each of the radiation detection signals taken at the predetermined sampling time intervals is due to an impulse response formed of a plurality of exponential functions with different attenuation time constants; and
(c) obtaining the live image and the mask image from corrected radiation detection signals determined by removing the lag-behind parts from the radiation detection signals, and obtaining the subtraction image.

This radiation detection signal processing method allows the radiographic apparatus according to the invention to be implemented in an advantageous manner.

In the above radiation detection signal processing method, the recursive computation for removing the lag-behind part from each of the radiation detection signals, preferably, is performed based on the following equations A-C:
Xₖ=Yₖ−Σₙ₌₁^{N}{αₙ·[1−exp(Tₙ)]·exp(Tₙ)·Sₙₖ} A
Tₙ=−Δt/τₙ B
Sₙₖ=Xₖ₋₁+exp(Tₙ)·Sₙ₍ₖ₋₁₎ C
where Δt: the sampling time interval;
k: a subscript representing a k-th point of time in a sampling time series;
Yₖ: a radiation detection signal taken at the k-th sampling time;
Xₖ: a corrected radiation detection signal with a lag-behind part removed from the signal Yₖ;
Xₖ₋₁: a signal Xₖ taken at a preceding point of time;
Sₙ₍ₖ₋₁₎: an Sₙₖ at a preceding point of time;
exp: an exponential function;
N: the number of exponential functions with different time constants forming the impulse response;
n: a subscript representing one of the exponential functions forming the impulse response;
αₙ: an intensity of exponential function n; and
τₙ: an attenuation time constant of exponential function n.

Where the recursive computation for removing the lag-behind part from each of the radiation detection signals is based on equations A-C, the radiographic apparatus that performs the recursive computation based on equations A-C may be implemented advantageously.

The mask image and live image may be picked up as follows. In one example, after the mask image is picked up, a contrast medium is given to the object under examination and the live image is picked up. In another example, the mask image and the live image are picked up by switching between a focus voltage and a defocus voltage to be applied to a radiation emitting device that emits radiation toward the object under examination. Further, examples of picking up the mask image and the live image by switching between the focus voltage and defocus voltage include the following modes. In one mode, with a contrast medium given to the object under examination, the defocus voltage is applied to the radiation emitting device to pick up the mask image, and thereafter the focus voltage is applied to the radiation emitting device to pick up the live image. In another mode, with a contrast medium given to the object under examination, the focus voltage is applied to the radiation emitting device to pick up the live image, and thereafter the defocus voltage is applied to the radiation emitting device to pick up the mask image.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a block diagram showing an overall construction of a fluoroscopic apparatus according to the invention;

FIG. 2 is a plan view of an FPD used in the fluoroscopic apparatus;

FIG. 3 is a schematic view showing a state of sampling X-ray detection signals during X-ray radiography by the fluoroscopic apparatus;

FIG. 4 is a flow chart showing a procedure of an X-ray detection signal processing method according to this invention;

FIG. 5 is a flow chart showing a recursive computation for time lag removal in the X-ray detection signal processing method according to this invention;

FIG. 6 is a view showing a state of radiation incidence; and

FIG. 7 is a view showing time lags.

### DESCRIPTION OF THE PREFERRED EMBODIMENTS

Preferred embodiments of this invention will be described in detail hereinafter with reference to the drawings.

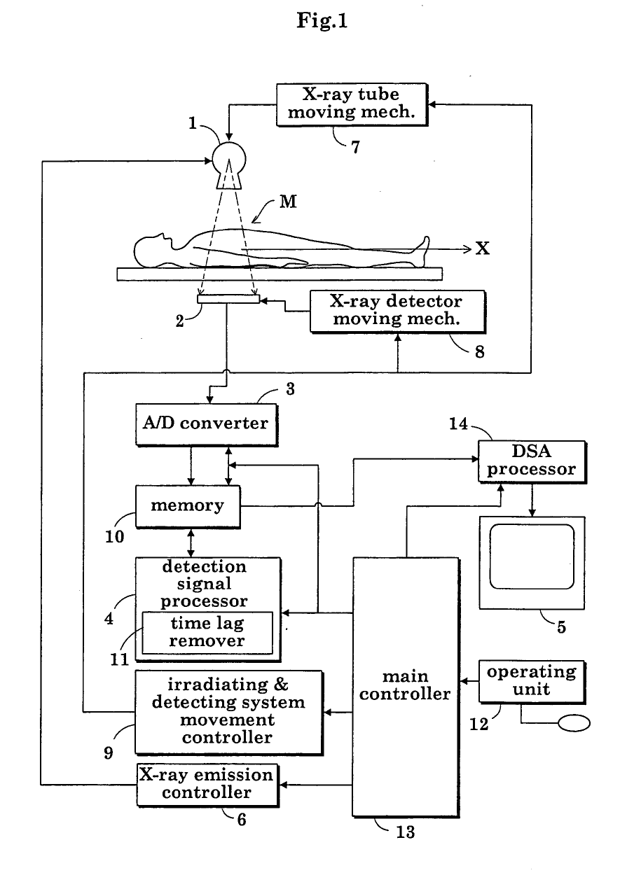

FIG. 1 is a block diagram showing an overall construction of a fluoroscopic apparatus according to this invention.

As shown in FIG. 1, the fluoroscopic apparatus includes an X-ray tube (radiation emitting device) 1 for emitting X rays toward a patient M, an FPD 2 (radiation detecting device) for detecting X rays transmitted through the patient M, an analog-to-digital converter 3 (signal sampling device) for digitizing X-ray detection signals (radiation detection signals) taken from the FPD (flat panel X-ray detector) 2 at predetermined sampling time intervals Δt, a detection signal processor 4 for creating X-ray images based on X-ray detection signals outputted from the analog-to-digital converter 3, and an image monitor 5 for displaying the X-ray images created by the detection signal processor 4. That is, the apparatus is constructed to acquire X-ray images from the X-ray detection signals taken from the FPD 2 by the analog-to-digital converter 3 as the patient M is irradiated with X rays, and display the acquired X-ray images on the screen of the image monitor 5. Each component of this apparatus will particularly be described hereinafter.

The X-ray tube 1 and FPD 2 are opposed to each other across the patient M. In time of X-ray radiography, the X-ray tube 1 is controlled by an X-ray emission controller 6 to emit X rays in the form of a cone beam to the patient M. At the same time, penetration X-ray images of the patient M produced by the X-ray emission are projected to an X-ray detecting surface of FPD 2.

The X-ray tube 1 and FPD 2 are movable back and forth along the patient M by an X-ray tube moving mechanism 7 and an X-ray detector moving mechanism 8, respectively. In moving the X-ray tube 1 and FPD 2, the X-ray tube moving mechanism 7 and X-ray detector moving mechanism 8 are controlled by an irradiating and detecting system movement controller 9 to move the X-ray tube 1 and FPD 2 together as opposed to each other, with the center of emission of X rays constantly in agreement with the center of the X-ray detecting surface of FPD 2. Of course, movement of the X-ray tube 1 and FPD 2 results in variations in the position of the patient M irradiated with X rays, hence movement of a radiographed site.

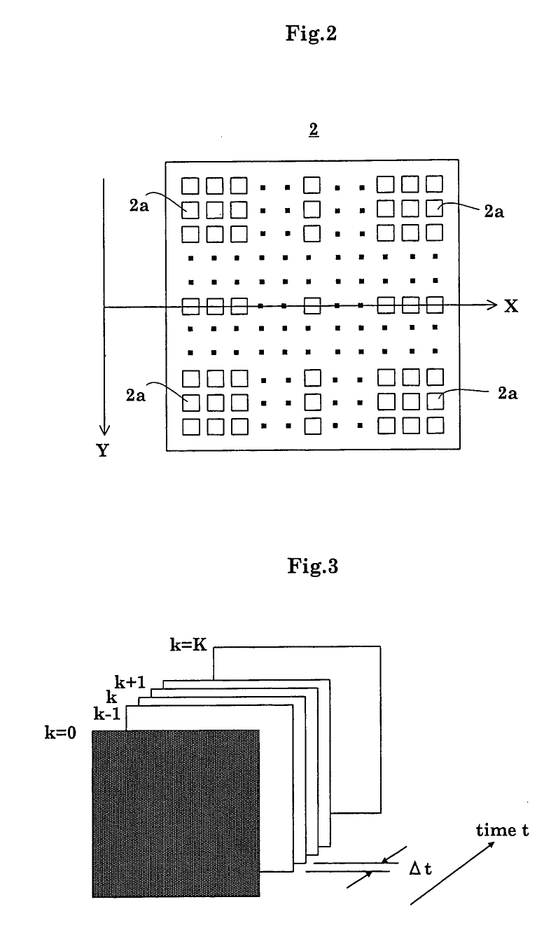

As shown in FIG. 2, the FPD 2 has numerous X-ray detecting elements 2a arranged longitudinally and transversely along the direction X of the body axis of patient M and the direction Y perpendicular to the body axis, on the X-ray detecting surface to which penetration X-ray images from the patient M are projected. For example, X-ray detecting elements 2a are arranged to form a matrix of 1536 by 1536 on the X-ray detecting surface about 30 cm long and 30 cm wide. Each X-ray detecting element 2a of FPD 2 corresponds to one pixel in an X-ray image created by the detection signal processor 4. Based on the X-ray detection signals taken from the FPD 2, the detection signal processor 4 creates an X-ray image corresponding to a penetration X-ray image projected to the X-ray detecting surface.

The analog-to-digital converter 3 continually takes X-ray detection signals for each X-ray image at sampling time intervals (t, and stores the X-ray detection signals for X-ray image creation in a memory 10 disposed downstream of the converter 3. An operation for sampling (extracting) the X-ray detection signals is started before X-ray irradiation.

That is, as shown in FIG. 3, all X-ray detection signals for a penetration X-ray image are collected at each period between the sampling intervals At, and are successively stored in the memory 10. The sampling of X-ray detection signals by the analog-to-digital converter 3 before an emission of X rays may be started manually by the operator or automatically as interlocked with a command for X-ray emission.

The memory 10 is arranged to store also corrected X-ray detection signals obtained by a time lag remover 11 described hereinafter, and stores the corrected X-ray detection signals as detection signals for live images and mask images. Alternatively, a memory for live images and mask images may be provided separately from the memory 10.

As shown in FIG. 1, the fluoroscopic apparatus in this embodiment includes a time lag remover 11 for computing corrected radiation detection signals free from time lags. A time lag is removed from each X-ray detection signal by a recursive computation based on an assumption that a lag-behind part included in each of the X-ray detection signals taken at the sampling time intervals from the FPD 2 is due to an impulse response formed of a plurality of exponential functions with different attenuation time constants.

With the FPD 2, an X-ray detection signal generated at each point of time, as shown in FIG. 7, includes signals corresponding to preceding X-ray emissions and remaining as a lag-behind part (hatched part). The time lag remover 11 removes this lag-behind part to produce a corrected, lag-free X-ray detection signal. Based on such lag-free X-ray detection signals, the detection signal processor 4 creates an X-ray image corresponding to a penetration X-ray image to be projected to the X-ray detecting surface.

Specifically, the time lag remover 11 performs a recursive computation for removing a lag-behind part from each X-ray detection signal by using the following equations A-C:
Xₖ=Yₖ−Σₙ₌₁^{N}{αₙ·[1−exp(Tₙ)]·exp(Tₙ)·Sₙₖ} A
Tₙ=−Δt/τₙ B
Sₙₖ=Xₖ₋₁+exp(Tₙ)·Sₙ₍ₖ₋₁₎ C
where Δt: the sampling time interval;
k: a subscript representing a k-th point of time in a sampling time series;
Yₖ: an X-ray detection signal taken at the k-th sampling time;

Xₖ: a corrected X-ray detection signal with a lag-behind part removed from the signal Yₖ;
Xₖ₋₁: a signal Xₖ taken at a preceding point of time;
Sₙ₍ₖ₋₁₎: an Sₙₖ at a preceding point of time;
exp: an exponential function;
N: the number of exponential functions with different time constants forming the impulse response;
n: a subscript representing one of the exponential functions forming the impulse response;
αₙ: an intensity of exponential function n; and
τₙ: an attenuation time constant of exponential function n.

The second term in equation A “Σₙ₌₁^{N}{αₙ·[1−exp(Tₙ)]·exp(Tₙ)·Sₙₖ}” corresponds to the lag-behind part. Thus, the apparatus in the first embodiment derives the corrected, lag-free X-ray detection signal Xₖ promptly from equations A-C constituting a compact recurrence formula.

In this embodiment, the analog-to-digital converter 3, detection signal processor 4, X-ray emission controller 6, irradiating and detecting system movement controller 9, time delay remover 11 and a DSA (subtraction) processor 14 described hereinafter are operable on instructions and data inputted from an operating unit 12 or on various commands outputted from a main controller 13 with progress of X-ray radiography.

As shown in FIG. 1, the fluoroscopic apparatus in this embodiment includes a DSA processor 14 for obtaining a live image and a mask image from the corrected X-ray detection signals stored in the memory 10, and obtaining a subtraction image by performing a subtraction process on the two images.

Next, an operation for performing X-ray radiography with the apparatus in this embodiment will particularly be described with reference to the drawings.

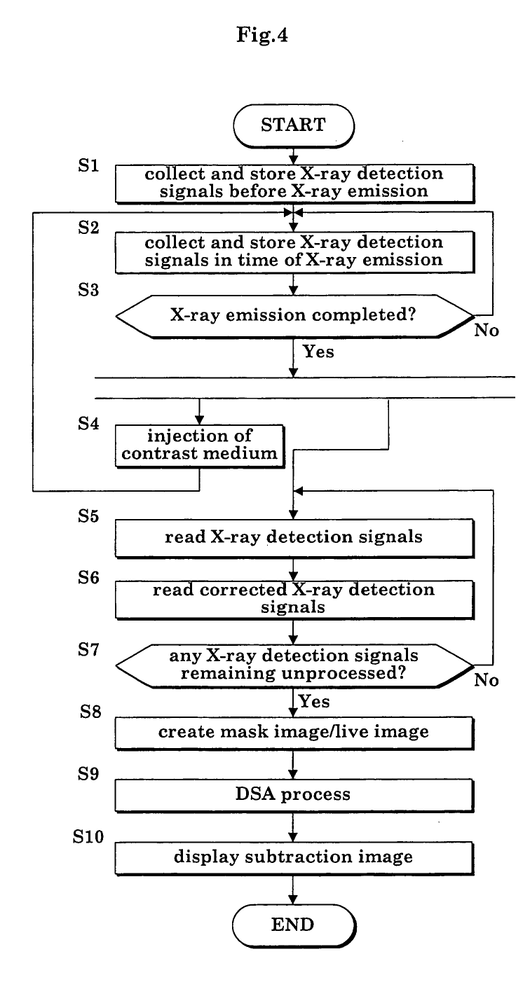

FIG. 4 is a flow chart showing a procedure of X-ray radiography in this embodiment.

[Step S1] The analog-to-digital converter 3 starts taking X-ray detection signals Yₖ for one X-ray image from the FPD 2 at each period between the sampling time intervals Δt (=1/30 second) before X-ray emission. The X-ray detection signals taken are stored in the memory 10.

[Step S2] In parallel with a continuous or intermittent X-ray emission to the patient M initiated by the operator, the analog-to-digital converter 3 continues taking X-ray detection signals Yₖ for one X-ray image at each period between the sampling time intervals At and storing the signals in the memory 10.

The collection and storage in the memory 10 of the X-ray detection signals Yₖ are both carried out in time of image pickup for a mask image and image pickup for a live image. When the operation moves from step S1 to step S2, step S2 and subsequent steps are executed to perform the image pickup for a mask image without using a contrast medium. When the operation moves from step S4 [injection of contrast medium] described hereinafter to step S2, step S2 and subsequent steps are executed to perform the image pickup for a live image. Also in a state of non-X-ray emission, such as in time of injection of the contrast medium during a shift from the image pickup for a mask image to the image pickup for a live image, the image detection signals Yₖ remain, while attenuating, because of lag-behind parts as shown in FIG. 7. Therefore, also in time of injection of the contrast medium, the collection and storage of the X-ray detection signals Yₖ are continued at the sampling time intervals Δt. In this way, the image pickup for a mask image and the image pickup for a live image are carried out continually.

[Step S3] When the X-ray emission is completed, the operation proceeds to step S4. When the X-ray emission is uncompleted, the operation returns to step S2.

[Step S4] When the X-ray emission for a mask image has been completed, that is when the image pickup for a mask image has been completed, the contrast medium is injected into the patient M to perform the next, image pickup for a live image in parallel with step S5. Then, the operation returns to step S2, and executes steps S2 and S3 as done for the mask image.

[Step S5] In parallel with step S4, X-ray detection signals Yₖ for one X-ray image collected in one sampling sequence are read from the memory 10.

[Step S6] The time lag remover 11 performs the recursive computation based on the equations A-C, and derives corrected X-ray detection signals Xₖ, i.e. pixel values, with lag-behind parts removed from the respective X-ray detection signals Yₖ.

[Step S7] When unprocessed X-ray detection signals Yₖ remain in the memory 10, the operation returns to step S5. When no unprocessed X-ray detection signals Yₖ remain, the operation proceeds to step S8. [Step S8] When the corrected X-ray detection signals Xₖ correspond to the X-ray detection signals Yₖ collected before the contrast medium injection and with lag-behind parts removed therefrom, these corrected signals Xₖ are determined to be for a mask image. The corrected X-ray detection signals Xₖ are read from the memory 10, and the DSA processor 14 creates a mask image. The mask image is created based on an arithmetic mean in the following equation D:

$$\begin{matrix}M = ( 1 / J ) \cdot ( {X}_{1} … + {X}_{k - 1} + {X}_{k} + … + {X}_{J} ) \\ = 1 / J \cdot {\sum }_{k = 1}^{J} [ {X}_{k} ]\end{matrix} \qquad D$$

where M: mask image; and
J: the number of signals Xₖ for creating the mask image.

When the corrected X-ray detection signals Xₖ correspond to the X-ray detection signals Yₖ collected after the contrast medium injection and with lag-behind parts removed therefrom, these corrected signals Xₖ are determined to be for a live image. The corrected X-ray detection signals Xₖ are read from the memory 10, and the DSA processor 14 creates a live image. The live image is created based on a weighted mean in the following equation E (hereinafter called “recursive process” where appropriate):
Rₖ=(1/K)·Xₖ+(1−1/K)·Rₖ₋₁ E
where Rₖ: live image after a k-th recursive process;
Rₖ₋₁: Rₖ at a preceding point of time; and
K: weight factor for the recursive process.

The recursive process in this embodiment will particularly be described assuming K=4. First, K is set to 0, and R₀ in equation E set to 0 as initial values before X-ray emission. In equation E, k=1 is set. A live image R₁ after a first recursive process is derived from equation E, i.e. R₁=(¼)·X₁+(¾)·R₀.

After incrementing k by 1 (k=k+1) in equation E, Rₖ₋₁ of a preceding point of time is substituted into equation E, and a live image Rₖ after a k-th recursive process is calculated.

[Step S9] When the mask image and live image have been created, the DSA processor 14 performs a DSA process on the mask image and live image to obtain a subtraction image.

[Step S10] The subtraction image created is displayed on the image monitor 5.

In this embodiment, the time lag remover 11 computes the corrected X-ray detection signals Xₖ corresponding to the X-ray detection signals Yₖ for one X-ray image, and the detection signal processor 4 creates an X-ray image, both at each period between the sampling time intervals Δt (=1/30 second). That is, the apparatus is constructed also for creating X-ray images one after another at a rate of about 30 images per second, and displaying the created X-ray images continuously. It is thus possible to perform a dynamic display of X-ray images.

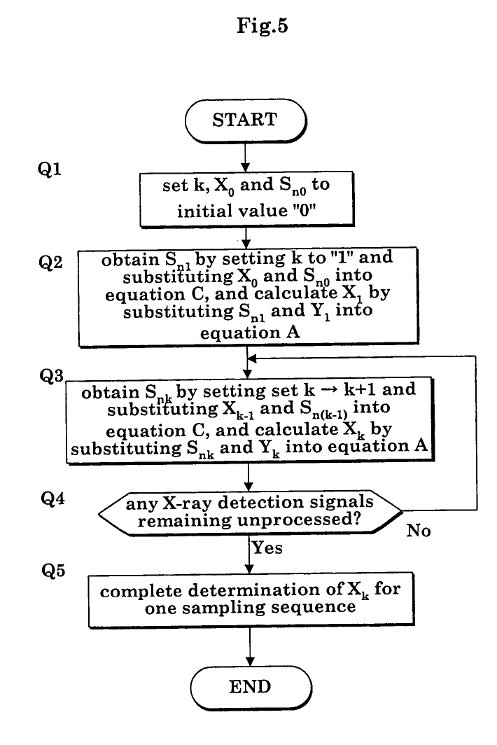

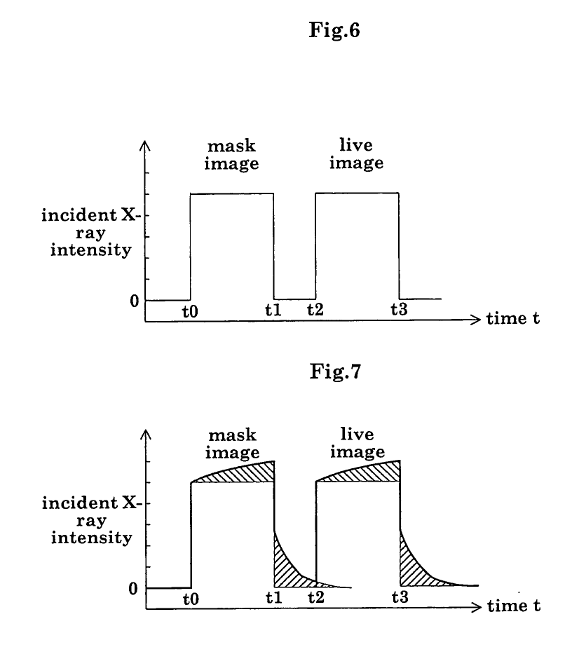

Next, the process of recursive computation carried out in step S6 in FIG. 4 by the time lag remover 11 will be described with reference to FIG. 5.

FIG. 5 is a flow chart showing a recursive computation process for time lag removal in the radiation detection signal processing method in this embodiment.

[Step Q1] A setting k=0 is made, and X₀=0 in equation A and Sₙ₀=0 in equation C are set as initial values before X-ray emission. Where the number of exponential functions is three (N=3), S₁₀, S₂₀ and S₃₀ are all set to 0.

[Step Q2] In equations A and C, k=1 is set. That is, S₁₁, S₂₁ and S₃₁ are derived from equation C, i.e. Sₙ₁=X₀+exp(Tₙ)·Sₙ₀. Further, a corrected X-ray detection signal is obtained by substituting S₁₁, S₂₁ and S₃₁ derived and X-ray detection signal Y₁ into equation A.

[Step Q3] After incrementing k by 1 (k=k+1) in equations A and C, Xₖ₋₁ of a preceding time is substituted into equation C, thereby obtaining S₁ₖ, S₂ₖ and S₃ₖ. Further, corrected X-ray detection signal Xₖ is obtained by substituting S₁ₖ, S₂ₖ and S₃ₖ derived and X-ray detection signal Yₖ into equation A.

[Step Q4] When there remain unprocessed X-ray detection signals Yₖ, the operation returns to step Q3. When no unprocessed X-ray detection signals Yₖ remain, the operation proceeds to the next step Q5.

[Step Q5] Corrected X-ray detection signals Xₖ for one sampling sequence (for one X-ray image) are obtained to complete the recursive computation for the one sampling sequence.

According to the fluoroscopic apparatus in this embodiment, as described above, a live image and a mask image are obtained from the X-ray detection signals Yₖ outputted from FPD 2 at sampling time intervals Δt (=1/30 second) as the patient M is irradiated with X rays emitted from the X-ray tube 1. A subtraction image is obtained by performing a subtraction process on the live image and mask image. The lag-behind part included in each of the X-ray detection signals Yₖ taken at sampling time intervals Δt is considered due to an impulse response formed of a plurality of exponential functions. The time lag remover 11 performs the recursive computation based on the equations A-C to remove the lag-behind parts from the respective X-ray detection signals Yₖ, thereby obtaining corrected X-ray detection signals Xₖ. In order to pick up a live image and a mask image continually, X-ray detection signals Yₖ for the live image and X-ray detection signals Yₖ for the mask image are continually collected at sampling time intervals Δt. Thus, the lag-behind parts of these signals are linked in time. When the live image is picked up after the mask image with lag-behind parts (FIG. 7), the lag-behind parts influence the live image. Such lag-behind parts influencing one another are used to eliminate fully the time delays of the X-ray detection signals due to the FPD 2 which is a radiation detecting device. The live image and mask image are obtained from the corrected detection signals Xₖ having the mutually influencing lag-behind parts removed. Consequently, the lag-behind parts are fully removed from the subtraction image obtained by performing the subtraction process on the live image and mask image.

This invention is not limited to the foregoing embodiment, but may be modified as follows:
(1) The embodiment described above employ an FPD as the radiation detecting device. This invention is applicable also to an apparatus having a radiation detecting device other than an FPD that causes time lags in X-ray detection signals.
(2) While the apparatus in the foregoing embodiment is a fluoroscopic apparatus, this invention is applicable also to an apparatus other than the fluoroscopic apparatus, such as an X-ray CT apparatus.
(3) The apparatus in the foregoing embodiment is designed for medical use. This invention is applicable not only to such medical apparatus but also to an apparatus for industrial use such as a nondestructive inspecting apparatus.
(4) The apparatus in the foregoing embodiment uses X rays as radiation. This invention is applicable also to an apparatus using radiation other than X rays.
(5) In the foregoing embodiment, a mask image is created by determining an arithmetic mean of corrected X-ray detection signals Xₖ, and a live image is created by performing a recursive process on the corrected X-ray detection signals Xₖ. The creation of a live image and a mask image is not limited to the described technique, but may adopt a usual technique for creating a live image and a mask image. For example, a mask image and a live image may be obtained from separate corrected X-ray detection signals Xₖ, respectively.
(6) In the foregoing embodiment, a fluoroscopic image picked up before injection of a contrast medium is used as a mask image, and a fluoroscopic image picked up of the patient after the contrast medium is injected as a live image. The mask and live images are not limited to the above fluoroscopic images. For example, a switching device may be disposed between the X-ray tube and a high-voltage generator (not shown) that drives the X-ray tube, for switching between a focus voltage and a defocus voltage. The defocus voltage is applied to the X-ray tube, after the contrast medium is given to the patient, to pick up an image free from high frequency components. Next, the focus voltage is applied to the X-ray tube to pick up an image with high frequency components remaining therein. Lag-behind parts are removed from X-ray detection signals for the former image free from high frequency components, and the resulting image may be used as a mask image. Lag-behind parts are removed from X-ray detection signals for the latter image with high frequency components remaining therein, and the resulting image may be used as a live image.
(7) In the foregoing embodiment, after picking up a mask image, a contrast medium is given to the patient and a live image is picked up. Where, as in modification (6) above, for example, a mask image and a live image are picked up continually by switching between the focus voltage and defocus voltage after injection of the contrast medium, the live image may be picked up first by applying the focus voltage, and thereafter the mask image may be picked up by applying the defocus voltage.

This invention may be embodied in other specific forms without departing from the spirit or essential attributes thereof and, accordingly, reference should be made to the appended claims, rather than to the foregoing specification, as indicating the scope of the invention.

1. A radiographic apparatus having radiation emitting means for emitting radiation toward an object under examination, radiation detecting means for detecting radiation transmitted through the object under examination, and signal sampling means for taking radiation detection signals from the radiation detecting means at predetermined sampling time intervals, to obtain a live image and a mask image based on the radiation detection signals outputted from the radiation detecting means at the predetermined sampling time intervals as radiation is emitted to the object under examination, the live image and the mask image being subjected to a subtraction process to obtain a subtraction image, said apparatus comprising:
time lag removing means for removing lag-behind parts from the radiation detection signals by a recursive computation, on an assumption that a lag-behind part included in each of said radiation detection signals taken at the predetermined sampling time intervals is due to an impulse response formed of one exponential function or a plurality of exponential functions with different attenuation time constants;
wherein, in order to pick up the live image and the mask image continually, the radiation detection signals relating to the live image and the radiation detection signals relating to the mask image are continually detected at the sampling time intervals, the lag-behind parts being removed from the radiation detection signals by said time lag removing means to obtain corrected radiation detection signals for forming the live image and the mask image, and obtaining the subtraction image.

2. A radiographic apparatus as defined in claim 1, wherein said time lag removing means is arranged to perform the recursive computation for removing the lag-behind part from each of the radiation detection signals, based on the following equations A-C:
Xₖ=Yₖ−Σₙ₌₁^{N}{αₙ·[1−exp(Tₙ)]·exp(Tₙ)·Sₙₖ} A
Tₙ=−Δt/τₙ B
Sₙₖ=Xₖ₋₁+exp(Tₙ)·Sₙ₍ₖ₋₁₎ C
where Δt: the sampling time interval;
k: a subscript representing a k-th point of time in a sampling time series;
Yₖ: a radiation detection signal taken at the k-th sampling time;
Xₖ: a corrected radiation detection signal with a lag-behind part removed from the signal Yₖ;
Xₖ₋₁: a signal Xₖ taken at a preceding point of time;
Sₙ₍ₖ₋₁₎: an Sₙₖ at a preceding point of time;
exp: an exponential function;
N: the number of exponential functions with different time constants forming the impulse response;
n: a subscript representing one of the exponential functions forming the impulse response;
αₙ: an intensity of exponential function n; and
τₙ: an attenuation time constant of exponential function n.

3. A radiographic apparatus as defined in claim 2, wherein said mask image is created by deriving an arithmetic mean of said corrected radiation detection signals Xₖ from the following equation D:
$$\begin{matrix}M = ( 1 / J ) \cdot ( {X}_{1} … + {X}_{k - 1} + {X}_{k} + … + {X}_{J} ) \\ = 1 / J \cdot {\sum }_{k = 1}^{J} [ {X}_{k} ]\end{matrix} \qquad D$$
where M: mask image; and
J: the number of signals Xₖ for creating the mask image.

4. A radiographic apparatus as defined in claim 2, wherein said live image is created by a recursive process based on the following equation E showing a weighted mean of said corrected radiation detection signals Xₖ:
Rₖ=(1/K)·Xₖ+(1−1/K)·Rₖ₋₁ E
where Rₖ: live image after a k-th recursive process;
Rₖ₋₁: Rₖ at a preceding point of time; and
K: weight factor for the recursive process.

5. A radiographic apparatus as defined in claim 1, wherein said radiation detecting means is a flat panel X-ray detector having numerous X-ray detecting elements arranged longitudinally and transversely on an X-ray detecting surface.

6. A radiographic apparatus as defined in claim 1, wherein said apparatus is a medical apparatus.

7. A radiographic apparatus as defined in claim 6, wherein said medical apparatus is a fluoroscopic apparatus.

8. A radiographic apparatus as defined in claim 6, wherein said medical apparatus is an X-ray CT apparatus.

9. A radiographic apparatus as defined in claim 1, wherein said apparatus is for industrial use.

10. A radiographic apparatus as defined in claim 9, wherein said apparatus for industrial use is a nondestructive inspecting apparatus.

11. A radiation detection signal processing method for taking, at predetermined sampling time intervals, radiation detection signals generated by irradiating an object under examination, creating a live image and a mask image based on the radiation detection signals outputted at the predetermined sampling time intervals, and performing a signal processing to obtain a subtraction image through a subtraction process, said method comprising the steps of:
(a) continually detecting the radiation detection signals relating to the live image and the radiation detection signals relating to the mask image at the sampling time intervals in order to pick up the live image and the mask image continually;
(b) removing lag-behind parts from the radiation detection signals by a recursive computation, on an assumption that a lag-behind part included in each of said radiation detection signals taken at the predetermined sampling time intervals is due to an impulse response formed of a plurality of exponential functions with different attenuation time constants; and
(c) obtaining the live image and the mask image from corrected radiation detection signals determined by removing the lag-behind parts from the radiation detection signals, and obtaining the subtraction image.

12. A radiation detection signal processing method as defined in claim 11, wherein the recursive computation for removing the lag-behind part from each of the radiation detection signals is performed based on the following equations A-C:
Xₖ=Yₖ−Σₙ₌₁^{N}{αₙ·[1−exp(Tₙ)]·exp(Tₙ)·Sₙₖ} A
Tₙ=−Δt/τₙ B
Sₙₖ=Xₖ₋₁+exp(Tₙ)·Sₙ₍ₖ₋₁₎ C
where Δt: the sampling time interval;
k: a subscript representing a k-th point of time in a sampling time series;
Yₖ: a radiation detection signal taken at the k-th sampling time;
Xₖ: a corrected radiation detection signal with a lag-behind part removed from the signal Yₖ;
Xₖ₋₁: a signal Xₖ taken at a preceding point of time;
Sₙ₍ₖ₋₁₎: an Sₙₖ at a preceding point of time;
exp: an exponential function;
N: the number of exponential functions with different time constants forming the impulse response;
n: a subscript representing one of the exponential functions forming the impulse response;
αₙ: an intensity of exponential function n; and
τₙ: attenuation time constant of exponential function n.

13. A radiation detection signal processing method as defined in claim 12, wherein said mask image is created by deriving an arithmetic mean of said corrected radiation detection signals Xₖ from the following equation D:
$$\begin{matrix}M = ( 1 / J ) \cdot ( {X}_{1} … + {X}_{k - 1} + {X}_{k} + … + {X}_{J} ) \\ = 1 / J \cdot {\sum }_{k = 1}^{J} [ {X}_{k} ]\end{matrix} \qquad D$$
where M: mask image; and
J: the number of signals Xₖ for creating the mask image.

14. A radiation detection signal processing method as defined in claim 12, wherein said live image is created by a recursive process based on the following equation E showing a weighted mean of said corrected radiation detection signals Xₖ:
Rₖ=(1/K)·Xₖ+(1−1/K)·Rₖ₋₁ E
where Rₖ: live image after a k-th recursive process;
Rₖ₋₁: Rₖ at a preceding point of time; and
K: weight factor for the recursive process.

15. A radiation detection signal processing method as defined in claim 11, wherein, after said mask image is picked up, a contrast medium is given to the object under examination and said live image is picked up.

16. A radiation detection signal processing method as defined in claim 11, wherein said mask image and said live image are picked up by switching between a focus voltage and a defocus voltage to be applied to radiation emitting means that emits radiation toward the object under examination.

17. A radiation detection signal processing method as defined in claim 16, wherein, with a contrast medium given to the object under examination, said defocus voltage is applied to said radiation emitting means to pick up said mask image, and thereafter said focus voltage is applied to said radiation emitting means to pick up said live image.

18. A radiation detection signal processing method as defined in claim 16, wherein, with a contrast medium given to the object under examination, said focus voltage is applied to said radiation emitting means to pick up said live image, and thereafter said defocus voltage is applied to said radiation emitting means to pick up said mask image.
